(19) United States
(12) Patent Application Publication
(10) Pub. No.: US 2006/0290800 A1
(43) Pub. Date: Dec. 28, 2006

(54) Lens actuating device and image pickup apparatus

(75) Inventor: Jun Ohkawa, Tokyo (JP)

Correspondence Address: RADER FISHMAN & GRAUER PLLC, LION BUILDING, 1233 20TH STREET N.W., SUITE 501, WASHINGTON, DC, 20036, US

(73) Assignee: Sony Corporation, Tokyo (JP)

(21) Appl. No.: 11/441,113

(22) Filed: May 26, 2006

(30) Foreign Application Priority Data
Jun. 24, 2005 (JP) 2005-185602

(51) Int. Cl. G02B 13/16

(52) U.S. Cl. 348/335

(57) ABSTRACT

Disclosed herein is a lens actuating device and an image pickup apparatus which are capable of actuating a lens to a proper lens position. Each one of the lens actuating device and the image pickup apparatus includes: a lens; an actuating unit for actuating the lens; a detecting unit for detecting a reference position of the lens; and an initialization control unit for moving the lens to the reference position detected by the detecting unit in each predetermined period of time, thereby to initialize the position of the lens.

### CROSS REFERENCES TO RELATED APPLICATIONS

The present invention contains subject matter related to Japanese Patent Application JP 2005-185602, filed in the Japanese Patent Office on Jun. 24, 2005, the entire contents of which being incorporated herein by reference.

### BACKGROUND OF THE INVENTION

The present invention relates to a lens actuating device and an image pickup apparatus which have a zooming function to change the angle of view, and more particularly to a lens actuating device and an image pickup apparatus which actuate a lens with a stepping motor.

There have heretofore been known various image pickup apparatus including single-lens reflex cameras, digital still cameras, video cameras, etc. Among those image pickup apparatus are image pickup apparatus having a stepping motor for actuating a lens and an open-loop control system for controlling the lens.

However, when the stepping motor is shocked or subjected to an excessive load, it may possibly undergo a loss of synchronism, bringing the lens out of a proper lens position.

To solve the above problem, Japanese patent Laid-open No. 2003-114370 discloses a zoom lens device having a detector for detecting the position of a zoom lens. When the zoom lens device is turned on, the position of the zoom lens is corrected by a stepping motor based on a signal from the detector.

### SUMMARY OF THE INVENTION

Surveillance cameras with stepping motors are continuously operated for a long period of time once they are turned on. Therefore, if the stepping motor suffers a loss of synchronism during its operation, then the surveillance camera tends to remain out of focus for a long period of time from the loss of synchronism. To avoid the drawback, the surveillance camera needs to be turned on again periodically to bring the stepping motor back into synchronism. However, since the surveillance camera is continuously operated for a long period of time, it is hard to turn on the surveillance camera to correct the lens position while it is in operation.

It is desirable to provide a lens actuating device and an image pickup apparatus which are capable of actuating a lens to a proper lens position.

To achieve the above desire, a lens actuating device according to the present invention has a lens, actuating means for actuating the lens, detecting means for detecting a reference position of the lens, and initialization control means for moving the lens to the reference position detected by the detecting means in each predetermined period of time, thereby to initialize the position of the lens.

To achieve the above desire, an image pickup apparatus according to the present invention has a lens, actuating means for actuating the lens, detecting means for detecting a reference position of the lens, and initialization control means for moving the lens to the reference position detected by the detecting means in each predetermined period of time, thereby to initialize the position of the lens.

According to the present invention, since the lens is moved to the reference position in each predetermined period of time, thereby to initialize the position of the lens, the lens actuating device and the image pickup apparatus are capable of actuating the lens to a proper lens position at all times.

The above and other objects, features, and advantages of the present invention will become apparent from the following description when taken in conjunction with the accompanying drawings which illustrate a preferred embodiment of the present invention by way of example.

### BRIEF DESCRIPTION OF THE DRAWINGS

FIG. 1 is a block diagram of an image pickup apparatus according to an embodiment of the present invention;

FIG. 2 is a front elevational view of a lens mechanism;

FIG. 3 is a side elevational view of the lens mechanism that is positioned at the time a reset sensor produces a low output signal;

FIG. 4 is a side elevational view of the lens mechanism that is positioned at the time the reset sensor produces a high output signal;

FIG. 5 is a perspective view of the reset sensor;

FIG. 6 is a circuit diagram of the reset sensor;

FIG. 7 is a diagram showing cam curves;

FIG. 8 is a flowchart of an initializing process according to the embodiment of the present invention;

FIG. 9 is a diagram illustrative of the movement of the lens in the initializing process;

FIG. 10 is a flowchart of a sequence for periodically starting the initializing process;

FIG. 11 is a flowchart of a process of displaying a still image in the initializing process; and

FIG. 12 is a flowchart of a sequence for starting the initializing process when there is a request for a preset position attainment mode.

### DETAILED DESCRIPTION OF THE PREFERRED EMBODIMENT

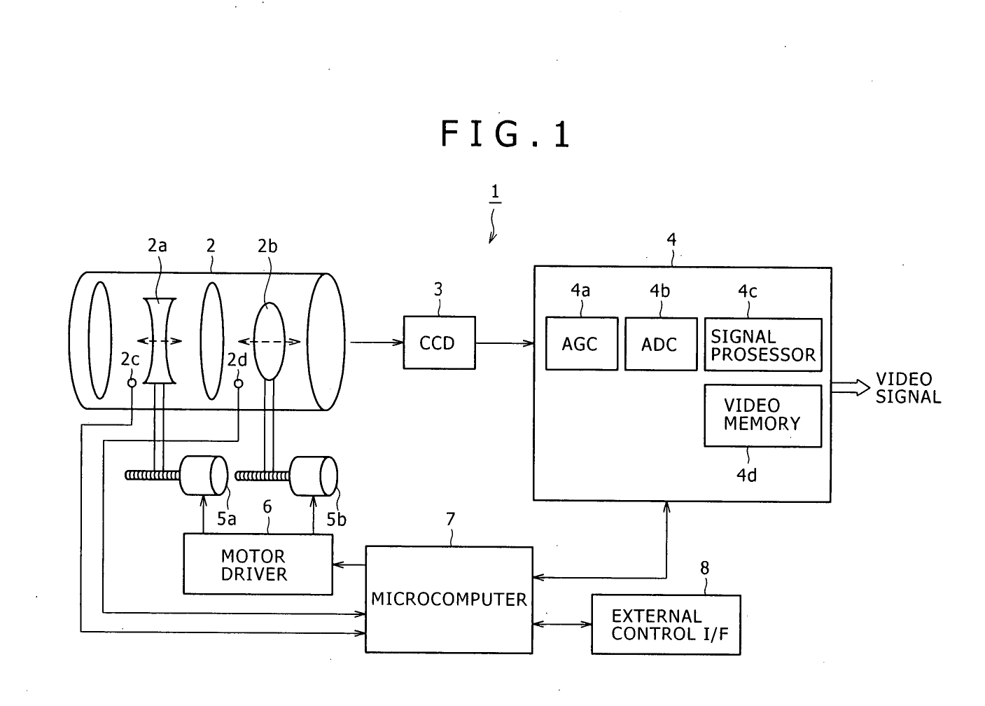

FIG. 1 shows in block form an image pickup apparatus 1 according to an embodiment of the present invention.

As shown in FIG. 1, the image pickup apparatus 1 comprises a lens barrel 2, a CCD (Charge Coupled Device) image sensor 3, a camera signal processor 4, stepping moors 5a, 5b, a motor driver 6, a microcomputer 7, and an external control interface 8.

The lens barrel 2 comprises a zoom lens 2a, a focus lens 2b, a zoom reset sensor 2c for detecting a reference position of the zoom lens 2a, and a focus reset sensor 2d for detecting a reference position of the focus lens 2b.

The camera signal processor 4 comprises an AGC (Automatic Gain Control) unit 4a for amplifying an analog signal, an ADC (Analog-to-Digital Converter) 4b for converting the amplified analog signal into a digital signal, a signal processor 4c for processing the digital signal into a video signal, and a video memory 4d for temporarily storing the video signal to produce a still image.

The motor driver 6 controls the stepping motors 5a, 5b according to commands from the microcomputer 7 to actuate the zoom lens 2a and the focus lens 2b.

The microcomputer 7 determines the reference positions of the zoom lens 2a and the focus lens 2b based on output signals from the zoom reset sensor 2c and the focus reset sensor 2d. The microcomputer 7 also controls the motor driver 6 based on the output signals from the zoom reset sensor 2c and the focus reset sensor 2d.

The external control interface 8 receives zooming and focusing instructions from a surveillance device or the like.

Light which is introduced through the lens barrel 2 and applied to the CCD 3 is photoelectrically converted into an electric signal, which is input to the camera signal processor 4. In the camera signal processor 4, the input signal is amplified by the AGC 4a and the amplified signal is converted into a digital signal by the ADC 4b. The digital signal is processed into a video signal by the signal processor 4c. The video signal produced by the signal processor 4c is stored in the memory 4d for producing a still image.

The zoom lens 2a and the focus lens 2b are actuated by the respective stepping motors 5a, 5b when drive commands are applied from the microcomputer 7 to the motor driver 6. Output level signals from the zoom reset sensor 2c and the focus reset sensor 2d are supplied to the microcomputer 7, which determines the reference positions of the zoom lens 2a and the focus lens 2b based on the output signals from the zoom reset sensor 2c and the focus reset sensor 2d. The zoom lens 2a and the focus lens 2b can also be controlled for zooming and focusing actions by zooming and focusing instructions which the microcomputer 7 receives through the external control interface 8.

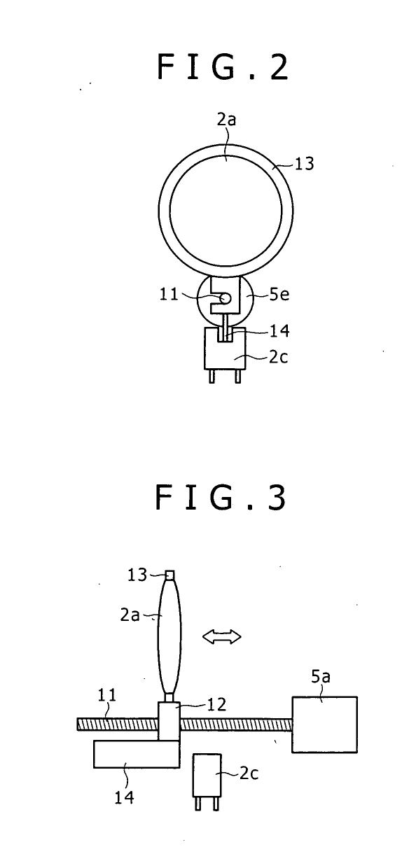

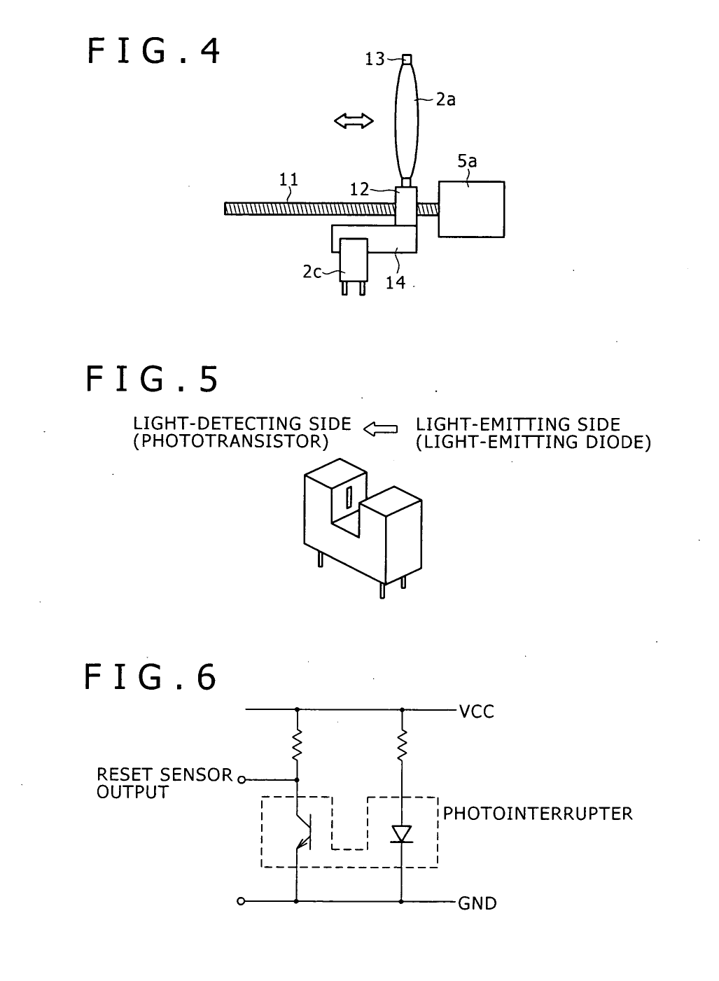

A lens mechanism of the lens barrel 2 will be described in detail below with reference to FIGS. 2 through 7. By way of example, the lens mechanism including the zoom lens 2a, the zoom reset sensor 2c, and the stepping motor 5a shown in FIG. 1 will be described below. FIG. 2 shows the lens mechanism in front elevation, and FIGS. 3 and 4 show the lens mechanism in side elevation.

The stepping motor 5a has a rotational shaft in the form of a screw 11 threaded through a nut 12. The zoom lens 2a is mounted on the nut 12 by a lens frame 13. When the stepping motor 5a is energized, the screw 11 rotates about its own axis to move the zoom lens 2a in one direction or the other along the screw 11. A shield plate 14 is attached to the nut 12. The zoom reset sensor 2c has a recess defined in a surface thereof for receiving a portion of the shield plate 14 therein. When the screw 11 is rotated about its own axis by the stepping motor 5a, the nut 12 is moved on and along the screw 11 to move the portion of the shield plate 14 into or out of the recess of the zoom reset sensor 2c, which produces a high or low output signal.

As shown in FIG. 5, the zoom reset sensor 2c comprises a photointerrupter having a light-emitting diode and a phototransistor which are spaced from each other across the recess. When the shield plate 14 is placed in the recess, blocking a light beam emitted from the light-emitting diode against being applied to the phototransistor as shown in FIG. 4, the photointerrupter produces a high output signal. When the shield plate 14 is placed out of the recess, allowing a light beam emitted from the light-emitting diode to be applied to the phototransistor as shown in FIG. 3, the photointerrupter produces a low output signal.

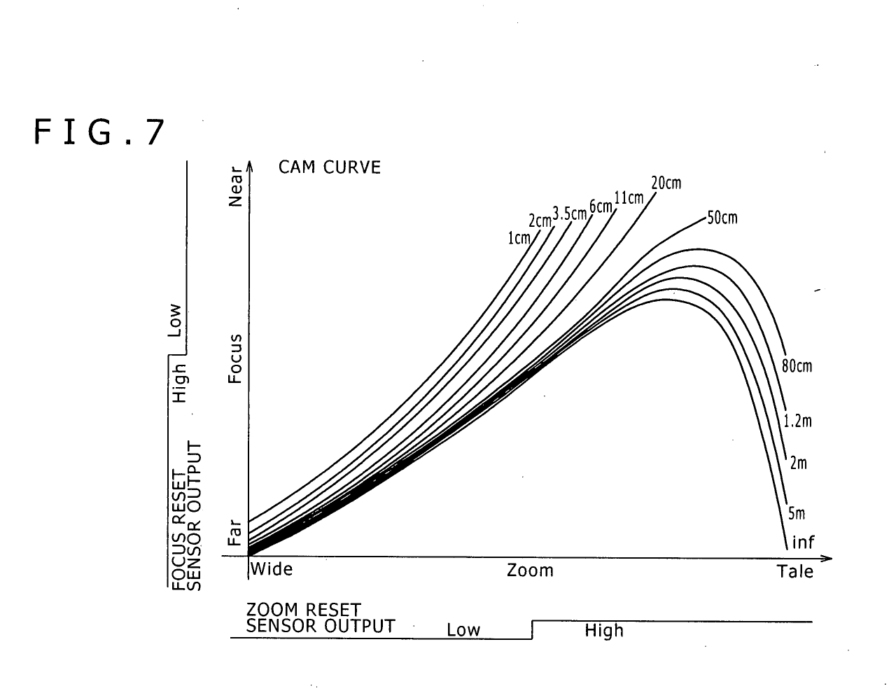

Specifically, as shown in FIG. 6, when the shield plate 14 is placed out of the recess, allowing a light beam emitted from the light-emitting diode to be applied to the phototransistor, the phototransistor is turned on, making the output signal of the zoom reset sensor 2c low in level. When the shield plate 14 is placed in the recess, blocking a light beam emitted from the light-emitting diode against being applied to the phototransistor, the phototransistor is turned off, making the output signal of the zoom reset sensor 2c high in level. The position where the output signal of the zoom reset sensor 2c changes from the high level to the low level or from the low level to the high level is used as a reference position. Accordingly, a zoom position and a focus position depending on the subject distance and the focal distance can be controlled as absolute positions based on cam curves shown in FIG. 7. Stated otherwise, a zoom position and a focus position can be controlled as absolute positions without the need for an absolute position sensor.

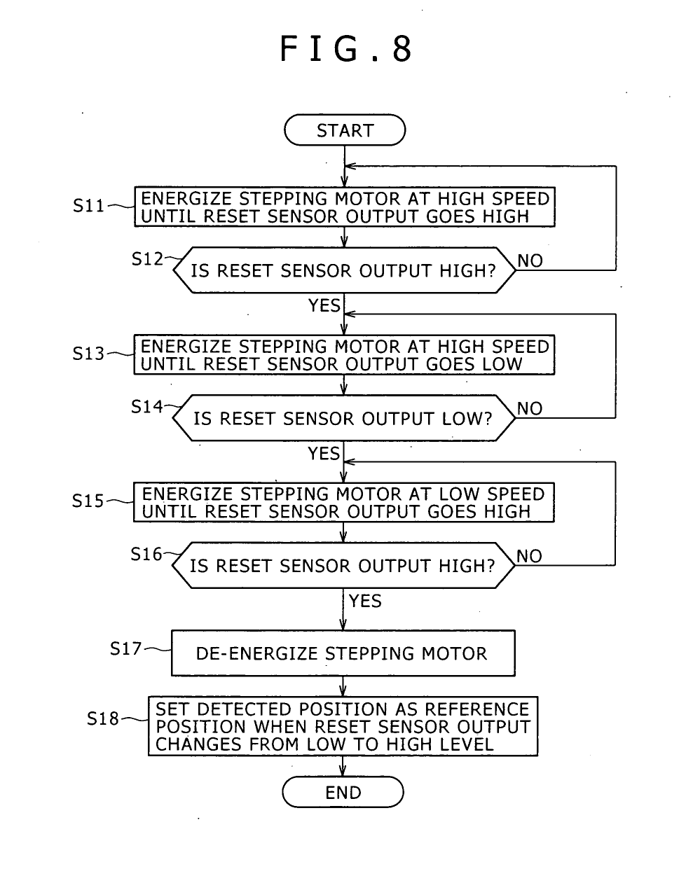

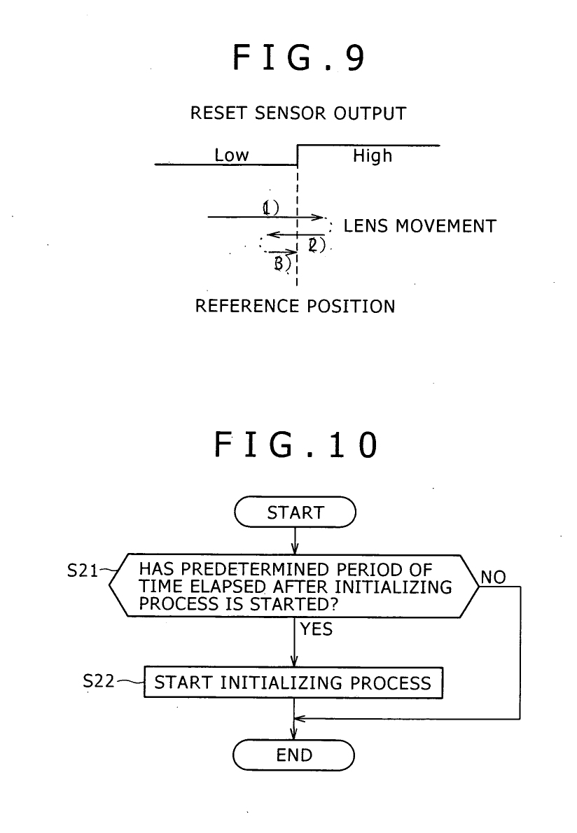

An initializing process for moving a lens to a reference position will be described below with reference to a flowchart shown in FIG. 8 and the relationship between a reset sensor and the lens shown in FIG. 9.

The stepping motor 5 is energized to move the lens at a high speed in step S11 until the output signal of the reset sensor goes high (see lens movement (1) in FIG. 9).

If the output signal of the reset sensor goes high in step S12, then the stepping motor 5 is reversed to move the lens at a high speed in step S13 until the output signal of the reset sensor goes low (see lens movement (2) in FIG. 9).

If the output signal of the reset sensor goes low in step S14, then the stepping motor 5 is reversed again to move the lens at a low speed in step S15 until the output signal of the reset sensor goes high (see lens movement (3) in FIG. 9).

If the output signal of the reset sensor goes high in step S16, then the stepping motor is de-energized in step S17. The position of the lens at this time is used as a reference position in step S18.

By thus detecting the reference position of the lens and energizing the stepping motor while counting the number of steps thereof based on the reference position, the lens can be controlled based on an absolute position.

Timing for performing the initializing process will be described below. According to the present embodiment, the lens can be actuated to a proper position by performing the initializing process with good timing without the need for determining whether the stepping motor undergoes a loss of synchronism or not.

FIG. 10 is a flowchart of a sequence for periodically starting the initializing process. In step S21 shown in FIG. 10, the microcomputer 7 counts down from the preceding cycle of the initializing process to determine whether or not a predetermined period of time has elapsed from the preceding cycle. If the predetermined period of time has elapsed from the preceding cycle of the initializing process in step S21, then control goes to step S22 in which the microcomputer 7 starts the initializing process.

If the microcomputer 7 performs the initializing process periodically, e.g., once a day or an hour, then a surveillance camera or the like that incorporates the image pickup apparatus 1, whose power supply is difficult to be turned off and on again for a long period of time, is prevented from staying out of focus for a long period of time.

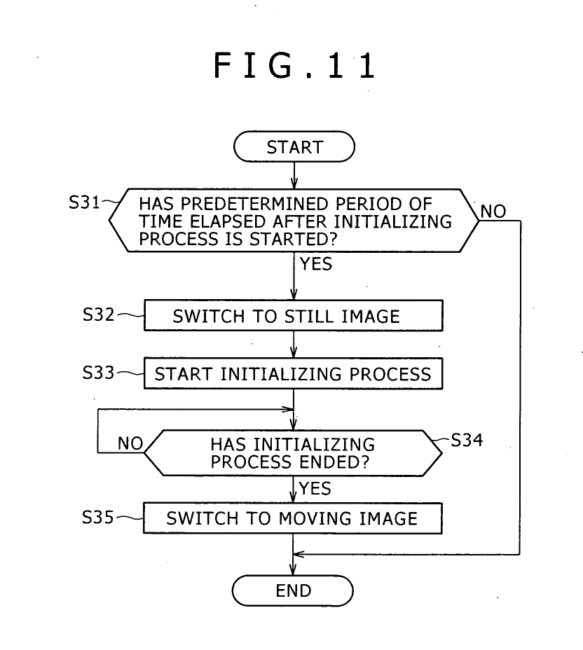

FIG. 11 is a flowchart of a process of switching to a still image during the initializing process. In step S31 shown in FIG. 11, the microcomputer 7 counts down from the preceding cycle of the initializing process to determine whether a predetermined period of time has elapsed from the preceding cycle or not. The microcomputer 7 temporary stores a video signal in the video memory 4d. If the predetermined period of time has elapsed from the preceding cycle of the initializing process in step S31, then control goes to step S32 in which the microcomputer 7 switches to a still image to be displayed. The still image is generated based on the video signal stored in the video memory 4d, and is an image which was displayed immediately before it has switched to the still image.

After the microcomputer 7 has displayed the still image on a display unit of a managing apparatus or the like (not shown), the microcomputer 7 starts the initializing process in step S33.

After the microcomputer 7 has started the initializing process in step S33, the microcomputer 7 determines whether or not the initializing process has ended in step S34. If the initializing process has ended in step S34, then control goes to step S35, and the microcomputer 7 switches to a moving image picked up by the image pickup apparatus 1.

Since the displayed image switches to a still image during the initializing process, the user does not have to see displayed image disruption during the initializing process. The microcomputer 7 may display a message “INITIALIZING PROCESS GOING ON” or the like rather than a still image during the initializing process.

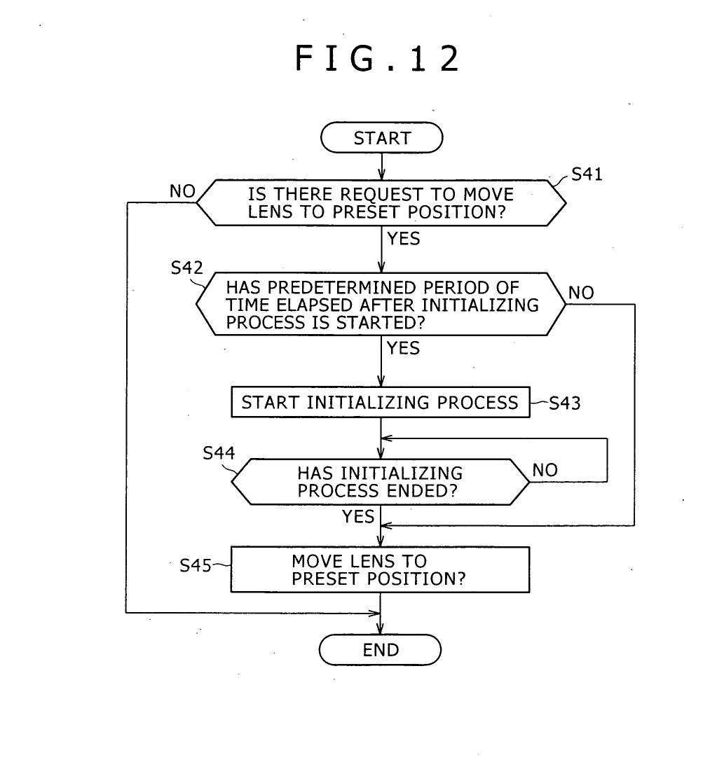

FIG. 12 is a flowchart of a sequence for starting the initializing process when there is a request for a preset position attainment mode. The preset position attainment mode is a mode for automatically moving the lens of a surveillance camera or the like to a preset zoom position (angle of view) or a preset focus position (subject distance), unlike a mode for manually moving the lens to a telephoto or wide-angle position. If the lens is to move to a preset zoom or focus position, then displayed image disruption during the initializing process may be tolerated.

In step S41 shown in FIG. 12, the microcomputer 7 determines whether or not there is a request for the preset position attainment mode supplied through the external interface 8. If there is a request for the preset position attainment mode, then the microcomputer 7 determines whether or not a predetermined period of time has elapsed from the preceding cycle of the initializing process in step S42.

If the predetermined period of time has elapsed from the preceding cycle of the initializing process in step S42, then the microcomputer 7 starts the initializing process in step S43.

After the microcomputer 7 has started the initializing process in step S43, the microcomputer 7 determines whether or not the initializing process has ended in step S44. If the initializing process has ended in step S44, then the microcomputer 7 moves the lens to a preset position depending on the request for the preset position attainment mode in step S45.

If the predetermined period of time has not elapsed from the preceding cycle of the initializing process in step S42, then control jumps to step S45 in which the microcomputer 7 moves the lens to a preset position depending on the request for the preset position attainment mode.

As described above, the initializing process is performed before the lens is actuated to the preset position. Therefore, when the lens is actuated to the preset position, the lens is reliably moved to a preset zoom position (angle of view) if it is a zoom lens or a preset focus position (subject distance) if it is a focus lens. The initializing process may be performed after elapse of a predetermined period of time, e.g., one day or one hour, and hence may not be performed unnecessarily. In the initializing process, the microcomputer 7 may switch to a still image to be displayed.

Although a certain preferred embodiment of the present invention has been shown and described in detail, it should be understood that various changes and modifications may be made therein without departing from the scope of the appended claims.

What is claimed is:

1. A lens actuating device comprising:
a lens;
actuating means for actuating said lens;
detecting means for detecting a reference position of said lens; and
initialization control means for moving said lens to the reference position detected by said detecting means in each predetermined period of time, thereby to initialize the position of said lens.

2. The lens actuating device according to claim 1, wherein said initialization control means comprises means for initializing the position of said lens when said actuating means moves said lens to a predetermined lens position.

3. An image pickup apparatus comprising:
a lens;
actuating means for actuating said lens;
detecting means for detecting a reference position of said lens; and
initialization control means for moving said lens to the reference position detected by said detecting means in each predetermined period of time, thereby to initialize the position of said lens.

4. The image pickup apparatus according to claim 3, wherein said initialization control means comprises means for initializing the position of said lens when said actuating means moves said lens.

5. The image pickup apparatus according to claim 3, further comprising:
display means for displaying an image picked up through said lens; and
memory means for temporarily storing said image;
wherein said initialization control means comprises means for displaying a still image of the image stored by said memory means on said display means when said initialization control means initializes the position of said lens.
